(19) United States
(12) Patent Application Publication
(10) Pub. No.: US 2017/0308365 A1
(43) Pub. Date: Oct. 26, 2017

(54) FACILITATING MOBILE DEVICE APPLICATION INSTALLATION USING A VEHICLE

(71) Applicant: General Motors LLC, Detroit, MI (US)

(72) Inventors: Alexander X. CERMAK, Grosse Pointe Woods, MI (US); Esteban CAMACHO, Belleville, MI (US); Jeffrey J. HAASE, Sterling Heights, MI (US); Ryan OLEJNICZAK, Clinton Township, MI (US)

(21) Appl. No.: 15/139,216

(22) Filed: Apr. 26, 2016

(51) Int. Cl. G06F 9/445; H04W 12/06; H04W 4/00

(52) U.S. Cl. CPC G06F 8/61; H04W 4/008; H04W 12/06

(57) ABSTRACT

A method carried out by a vehicle for facilitating installation of a vehicle access application on a mobile device. The method begins by establishing short range communication with a mobile device. The vehicle sends identification information to a remote facility, wherein the identification information includes information pertaining to the vehicle, a user of the vehicle, and/or the mobile device. The vehicle receives a response from the remote facility wherein the response indicates eligibility of the user to control one or more vehicle operations using the application. The vehicle determines whether the application is installed on the mobile device and prompts the user of the vehicle to install the application to the mobile device when it is determined that the application is not installed on the mobile device.

### TECHNICAL FIELD

The present invention relates to installing registration-based mobile device applications that are used to access vehicle information and control vehicle functions.

### BACKGROUND

Many vehicles now come equipped with short range communication abilities, such as the ability to wirelessly communicate with a mobile device carried by a user of the vehicle. Mobile applications are being developed by OEMs that enable an authorized mobile device user of the vehicle to access vehicle information and functions remotely from their phone or other mobile device. Typically, these mobile device applications may be available for download to mobile devices, with free or fee-based registration then being required for the user to be able to access their vehicle via the application. Registration typically involves confirming that the registering user is authorized to access the vehicle, and this may include the requirement that an account be established by the user with the OEM or its telematics service provider. The account may be a fee-based subscription or may be a free account, such as in the event the account and vehicle access are provided by the OEM or dealer as a standard option or included as part of an entertainment or upgrade package. In any case, vehicle users may not be aware of availability of the mobile device application, may not be aware of how to locate the application for download, and/or may not know whether their mobile device is capable of using the application.

### SUMMARY

According to an embodiment of the invention, there is provided a method of facilitating installation of an application on a mobile device wherein the method is carried out by a vehicle and wherein the method comprises the steps of:
(a) establishing short range communication with a mobile device of a user of the vehicle;
(b) sending identification information to a remote facility, wherein the identification information includes information pertaining to the vehicle, the user, and/or the mobile device;
(c) receiving a response from the remote facility indicating eligibility of the user to control one or more vehicle operations via the mobile device using the application;
(d) determining whether the application is installed on the mobile device; and
(e) prompting the user of the vehicle to install the application to the mobile device when it is determined that the application is not installed on the mobile device.

In accordance with another embodiment of the invention, there is provided a method of facilitating downloading of an application to a mobile device located at a vehicle wherein the method is carried out by the vehicle and wherein the method comprises the steps of:
(a) establishing communication with a mobile device of a user of the vehicle;
(b) in response to step (a), sending identification information to a remote facility that indicates that the user has a mobile device;
(c) receiving a response from the remote facility indicating eligibility of the user to access the vehicle via the mobile device using the application;
(d) prompting the user to indicate whether to download and/or install the application;
(e) receiving an indication from the user in response to step (c) that the application should be downloaded;
(f) accessing a download link for the application in response to the user's indication that the application should be downloaded; and
(g) using the download link to initiate download of the application to the mobile device.

### BRIEF DESCRIPTION OF THE DRAWINGS

One or more embodiments of the invention will hereinafter be described in conjunction with the appended drawings, wherein like designations denote like elements, and wherein:

FIG. 1 is a block diagram depicting an embodiment of a communications system that is capable of utilizing the method disclosed herein; and

FIG. 2 is an embodiment of a method of facilitating installation of an application on a mobile device.

### DETAILED DESCRIPTION OF THE ILLUSTRATED EMBODIMENT(S)

The methods described below are carried out by a vehicle to facilitate the installation and setup of an application on a vehicle user's mobile device to thereby enable the user to wirelessly access the vehicle from the mobile device via the application. This includes steps carried out automatically by the vehicle to assist the user with the installation of the application. This automation of at least a part of the installation process may help increase utilization of the application by vehicle users, thereby improving customer satisfaction by better enabling users to take advantage of the remote access features available via the application on their mobile device.

According to one embodiment provided herein, a vehicle establishes short range communication with user's mobile device. Next, the vehicle obtains information pertaining to the vehicle, the user, and/or the mobile device and sends this information to a remote facility. The vehicle then receives a response from the remote facility as to the eligibility of the user to control one or more vehicle functions of the application. For example, the eligibility may be based on whether the vehicle is capable of being accessed remotely for use by the application or whether the user's mobile device is capable of installing and running the application. The vehicle determines whether the application is already installed on the mobile device. If eligibility is confirmed, but the application has not been installed, then the vehicle may prompt the user to install the application onto the mobile device. This may be carried out, for example, by sending the mobile device instructions to proceed to a mobile application store listing for the application so that it may be downloaded easily by the user.

### Communications System—

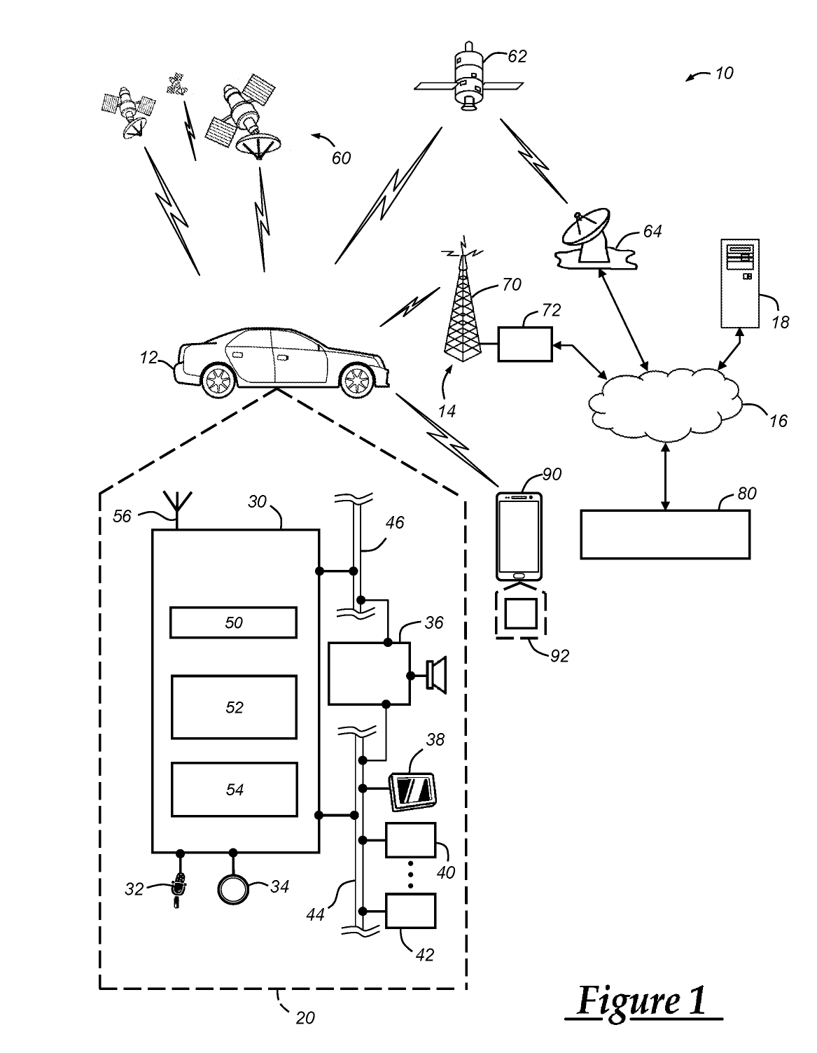

With reference to FIG. 1, there is shown an operating environment that comprises a mobile vehicle communications system 10 and that can be used to implement the methods disclosed herein. Communications system 10 generally includes a vehicle 12, one or more wireless carrier systems 14, a land communications network 16, a computer 18, a remote facility 80, and a mobile device 90. It should be understood that the disclosed method can be used with any number of different systems and is not specifically limited to the operating environment shown here. Also, the architecture, construction, setup, and operation of the system 10 and its individual components are generally known in the art. Thus, the following paragraphs simply provide a brief overview of one such communications system 10; however, other systems not shown here could employ the disclosed methods as well.

Vehicle 12 is depicted in the illustrated embodiment as a passenger car, but it should be appreciated that any other vehicle including motorcycles, trucks, sports utility vehicles (SUVs), recreational vehicles (RVs), marine vessels, aircraft, etc., can also be used. Some of the vehicle electronics 20 are shown generally in FIG. 1 and include a telematics unit 30, a microphone 32, one or more pushbuttons or other control inputs 34, an audio system 36, a visual display 38, and a GPS module 40 as well as a number of other vehicle system modules (VSMs) 42. Some of these devices can be connected directly to the telematics unit such as, for example, microphone 32 and pushbutton(s) 34, whereas others are indirectly connected using one or more network connections, such as a communications bus 44 or an entertainment bus 46. Examples of suitable network connections include a controller area network (CAN), a media oriented system transfer (MOST), a local interconnection network (LIN), a local area network (LAN), and other appropriate connections such as Ethernet or others that conform with known ISO, SAE and IEEE standards and specifications, to name but a few.

Telematics unit 30 is itself a vehicle system module (VSM) and can be implemented as an OEM-installed (embedded) or aftermarket device that is installed in the vehicle and that enables wireless voice and/or data communication over wireless carrier system 14 and via wireless networking. This enables the vehicle to communicate with remote facility 80, other telematics-enabled vehicles, or some other entity or device. The telematics unit preferably uses radio transmissions to establish a communications channel (a voice channel and/or a data channel) with wireless carrier system 14 so that voice and/or data transmissions can be sent and received over the channel. By providing both voice and data communication, telematics unit 30 enables the vehicle to offer a number of different services including those related to navigation, telephony, emergency assistance, diagnostics, infotainment, etc. Data can be sent either via a data connection, such as via packet data transmission over a data channel, or via a voice channel using techniques known in the art. For combined services that involve both voice communication (e.g., with a live advisor or voice response unit at the remote facility 80) and data communication (e.g., to provide GPS location data or vehicle diagnostic data to the remote facility 80), the system can utilize a single call over a voice channel and switch as needed between voice and data transmission over the voice channel, and this can be done using techniques known to those skilled in the art.

According to one embodiment, telematics unit 30 utilizes cellular communication according to GSM, CDMA, or LTE standards and thus includes a standard cellular chipset 50 for voice communications like hands-free calling, a wireless modem for data transmission, an electronic processing device 52, one or more digital memory devices 54, and a dual antenna 56. It should be appreciated that the modem can either be implemented through software that is stored in the telematics unit and is executed by processor 52, or it can be a separate hardware component located internal or external to telematics unit 30. The modem can operate using any number of different standards or protocols such as LTE, EVDO, CDMA, GPRS, and EDGE. Wireless networking between the vehicle and other networked devices can also be carried out using telematics unit 30. For this purpose, telematics unit 30 can be configured to communicate wirelessly according to one or more wireless protocols, including short range wireless communication (SRWC) such as any of the IEEE 802.11 protocols, WiMAX, ZigBee™, Wi-Fi direct, Bluetooth™, or near field communication (NFC). When used for packet-switched data communication such as TCP/IP, the telematics unit can be configured with a static IP address or can be set up to automatically receive an assigned IP address from another device on the network such as a router or from a network address server.

Processor 52 can be any type of device capable of processing electronic instructions including microprocessors, microcontrollers, host processors, controllers, vehicle communication processors, and application specific integrated circuits (ASICs). It can be a dedicated processor used only for telematics unit 30 or can be shared with other vehicle systems. Processor 52 executes various types of digitally-stored instructions, such as software or firmware programs stored in memory 54, which enable the telematics unit to provide a wide variety of services. For instance, processor 52 can execute programs or process data to carry out at least a part of the method discussed herein.

Telematics unit 30 can be used to provide a diverse range of vehicle services that involve wireless communication to and/or from the vehicle. Such services include: turn-by-turn directions and other navigation-related services that are provided in conjunction with the GPS-based vehicle navigation module 40; airbag deployment notification and other emergency or roadside assistance-related services that are provided in connection with one or more collision sensor interface modules such as a body control module (not shown); diagnostic reporting using one or more diagnostic modules; and infotainment-related services where music, webpages, movies, television programs, videogames and/or other information is downloaded by an infotainment module (not shown) and is stored for current or later playback. The above-listed services are by no means an exhaustive list of all of the capabilities of telematics unit 30, but are simply an enumeration of some of the services that the telematics unit is capable of offering. Furthermore, it should be understood that at least some of the aforementioned modules could be implemented in the form of software instructions saved internal or external to telematics unit 30, they could be hardware components located internal or external to telematics unit 30, or they could be integrated and/or shared with each other or with other systems located throughout the vehicle, to cite but a few possibilities. In the event that the modules are implemented as VSMs 42 located external to telematics unit 30, they could utilize vehicle bus 44 to exchange data and commands with the telematics unit.

GPS module 40 receives radio signals from a constellation 60 of GPS satellites. From these signals, the module 40 can determine vehicle position that is used for providing navigation and other position-related services to the vehicle driver. Navigation information can be presented on the display 38 (or other display within the vehicle) or can be presented verbally such as is done when supplying turn-by-turn navigation. The navigation services can be provided using a dedicated in-vehicle navigation module (which can be part of GPS module 40), or some or all navigation services can be done via telematics unit 30, wherein the position information is sent to a remote location for purposes of providing the vehicle with navigation maps, map annotations (points of interest, restaurants, etc.), route calculations, and the like. The position information can be supplied to remote facility 80 or other remote computer system, such as computer 18, for other purposes, such as fleet management. Also, new or updated map data can be downloaded to the GPS module 40 from the remote facility 80 via the telematics unit 30.

Apart from the telematics unit 30, audio system 36, and GPS module 40, the vehicle 12 can include other vehicle system modules (VSMs) 42 in the form of electronic hardware components that are located throughout the vehicle and typically receive input from one or more sensors and use the sensed input to perform diagnostic, monitoring, control, reporting and/or other functions. Each of the VSMs 42 is preferably connected by communications bus 44 to the other VSMs, as well as to the telematics unit 30, and can be programmed to run vehicle system and subsystem diagnostic tests. As examples, one VSM 42 can be an engine control module (ECM) that controls various aspects of engine operation such as fuel ignition and ignition timing, another VSM 42 can be a powertrain control module that regulates operation of one or more components of the vehicle powertrain, and another VSM 42 can be a body control module that governs various electrical components located throughout the vehicle, like the vehicle's power door locks and headlights. According to one embodiment, the engine control module is equipped with on-board diagnostic (OBD) features that provide myriad real-time data, such as that received from various sensors including vehicle emissions sensors, and provide a standardized series of diagnostic trouble codes (DTCs) that allow a technician to rapidly identify and remedy malfunctions within the vehicle. As is appreciated by those skilled in the art, the above-mentioned VSMs are only examples of some of the modules that may be used in vehicle 12, as numerous others are also possible.

Vehicle electronics 20 also includes a number of vehicle user interfaces that provide vehicle occupants with a means of providing and/or receiving information, including microphone 32, pushbutton(s) 34, audio system 36, and visual display 38. As used herein, the term ‘vehicle user interface’ broadly includes any suitable form of electronic device, including both hardware and software components, which is located on the vehicle and enables a vehicle user to communicate with or through a component of the vehicle. Microphone 32 provides audio input to the telematics unit to enable the driver or other occupant to provide voice commands and carry out hands-free calling via the wireless carrier system 14. For this purpose, it can be connected to an on-board automated voice processing unit utilizing human-machine interface (HMI) technology known in the art. The pushbutton(s) 34 allow manual user input into the telematics unit 30 to initiate wireless telephone calls and provide other data, response, or control input. Separate pushbuttons can be used for initiating emergency calls versus regular service assistance calls to the remote facility 80. Audio system 36 provides audio output to a vehicle occupant and can be a dedicated, stand-alone system or part of the primary vehicle audio system. According to the particular embodiment shown here, audio system 36 is operatively coupled to both vehicle bus 44 and entertainment bus 46 and can provide AM, FM and satellite radio, CD, DVD and other multimedia functionality. This functionality can be provided in conjunction with or independent of the infotainment module described above. Visual display 38 is preferably a graphics display, such as a touch screen on the instrument panel or a heads-up display reflected off of the windshield, and can be used to provide a multitude of input and output functions. Various other vehicle user interfaces can also be utilized, as the interfaces of FIG. 1 are only an example of one particular implementation.

Wireless carrier system 14 is preferably a cellular telephone system that includes a plurality of cell towers 70 (only one shown), one or more mobile switching centers (MSCs) 72, as well as any other networking components required to connect wireless carrier system 14 with land network 16. Each cell tower 70 includes sending and receiving antennas and a base station, with the base stations from different cell towers being connected to the MSC 72 either directly or via intermediary equipment such as a base station controller. Cellular system 14 can implement any suitable communications technology, including for example, analog technologies such as AMPS, or the newer digital technologies such as CDMA (e.g., CDMA2000) or GSM/GPRS. As will be appreciated by those skilled in the art, various cell tower/base station/MSC arrangements are possible and could be used with wireless system 14. For instance, the base station and cell tower could be co-located at the same site or they could be remotely located from one another, each base station could be responsible for a single cell tower or a single base station could service various cell towers, and various base stations could be coupled to a single MSC, to name but a few of the possible arrangements.

Apart from using wireless carrier system 14, a different wireless carrier system in the form of satellite communication can be used to provide uni-directional or bi-directional communication with the vehicle. This can be done using one or more communication satellites 62 and an uplink transmitting station 64. Uni-directional communication can be, for example, satellite radio services, wherein programming content (news, music, etc.) is received by transmitting station 64, packaged for upload, and then sent to the satellite 62, which broadcasts the programming to subscribers. Bi-directional communication can be, for example, satellite telephony services using satellite 62 to relay telephone communications between the vehicle 12 and station 64. If used, this satellite telephony can be utilized either in addition to or in lieu of wireless carrier system 14.

Land network 16 may be a conventional land-based telecommunications network that is connected to one or more landline telephones and connects wireless carrier system 14 to remote facility 80. For example, land network 16 may include a public switched telephone network (PSTN) such as that used to provide hardwired telephony, packet-switched data communications, and the Internet infrastructure. One or more segments of land network 16 could be implemented through the use of a standard wired network, a fiber or other optical network, a cable network, power lines, other wireless networks such as wireless local area networks (WLANs), or networks providing broadband wireless access (BWA), or any combination thereof. Furthermore, remote facility 80 need not be connected via land network 16, but could include wireless telephony equipment so that it can communicate directly with a wireless network, such as wireless carrier system 14.

Computer 18 can be one of a number of computers accessible via a private or public network such as the Internet. Each such computer 18 can be used for one or more purposes, such as a web server accessible by the vehicle via telematics unit 30 and wireless carrier 14. Other such accessible computers 18 can be, for example: a service center computer where diagnostic information and other vehicle data can be uploaded from the vehicle via the telematics unit 30; a client computer used by the vehicle owner or other subscriber for such purposes as accessing or receiving vehicle data or to setting up or configuring subscriber preferences or controlling vehicle functions; or a third party repository to or from which vehicle data or other information is provided, whether by communicating with the vehicle 12 or remote facility 80, or both. A computer 18 can also be used for providing Internet connectivity such as DNS services or as a network address server that uses DHCP or other suitable protocol to assign an IP address to the vehicle 12.

Remote facility 80 is designed to provide the vehicle electronics 20 with a number of different system back-end functions. The remote facility 80 may include one or more switches, servers, databases, live advisors, as well as an automated voice response system (VRS), all of which are known in the art. Remote facility 80 may include any or all of these various components and, preferably, each of the various components are coupled to one another via a wired or wireless local area network. Remote facility 80 may receive and transmit data via a modem connected to land network 16. A database at the remote facility can store account information such as subscriber authentication information, vehicle identifiers, profile records, behavioral patterns, and other pertinent subscriber information. Data transmissions may also be conducted by wireless systems, such as 882.11x, GPRS, and the like. Although the illustrated embodiment has been described as it would be used in conjunction with a manned remote facility 80 using a live advisor, it will be appreciated that the remote facility can instead utilize a VRS as an automated advisor or, a combination of the VRS and the live advisor can be used.

Mobile device 90 is a non-vehicle device, meaning that it is not a part of vehicle 12 or vehicle electronics 20. The mobile device includes: hardware, software, and/or firmware enabling cellular telecommunications and/or short range wireless communication (SRWC), as well as other wireless device functions and applications. The hardware of mobile device 90 comprises a processor and memory for storing the software, firmware, etc. This memory may include volatile RAM or other temporary powered memory, as well as a non-transitory computer readable medium that stores some or all of the software needed to carry out the various external device functions discussed herein. The mobile device processor and software stored in the memory enable various software applications, which may be preinstalled or installed by the user (or manufacturer) (e.g., having a software application or graphical user interface (GUI)). This may include an application 92 that can allow a vehicle user to communicate with vehicle 12 and/or to control various aspects or functions of the vehicle—e.g., among other things, allowing the user to remotely lock/unlock vehicle doors, turn the vehicle ignition on or off, check the vehicle tire pressures, fuel level, oil life, etc. The application may also be used to enable the user of device 90 to view information pertaining to the vehicle (e.g., the current location of the vehicle, whether the vehicle is locked or unlocked) and/or pertaining to an account associated with the user or vehicle. In the illustrated embodiment, mobile device 90 is is a handheld wireless device; in particular, a smartphone having cellular telephone capabilities as well as SRWC capability using an 802.11 protocol and/or a Bluetooth™ protocol such as Bluetooth™ Low Energy (BLE). In other embodiments, device 90 may be a tablet, laptop computer, or any other suitable device having the same or similar wireless communication capability. Using one or more of these wireless communication technologies, application 92 enables the user to wirelessly connect mobile device 90 with vehicle 12 as well as the remote facility 80 or call center advisors.

### Method—

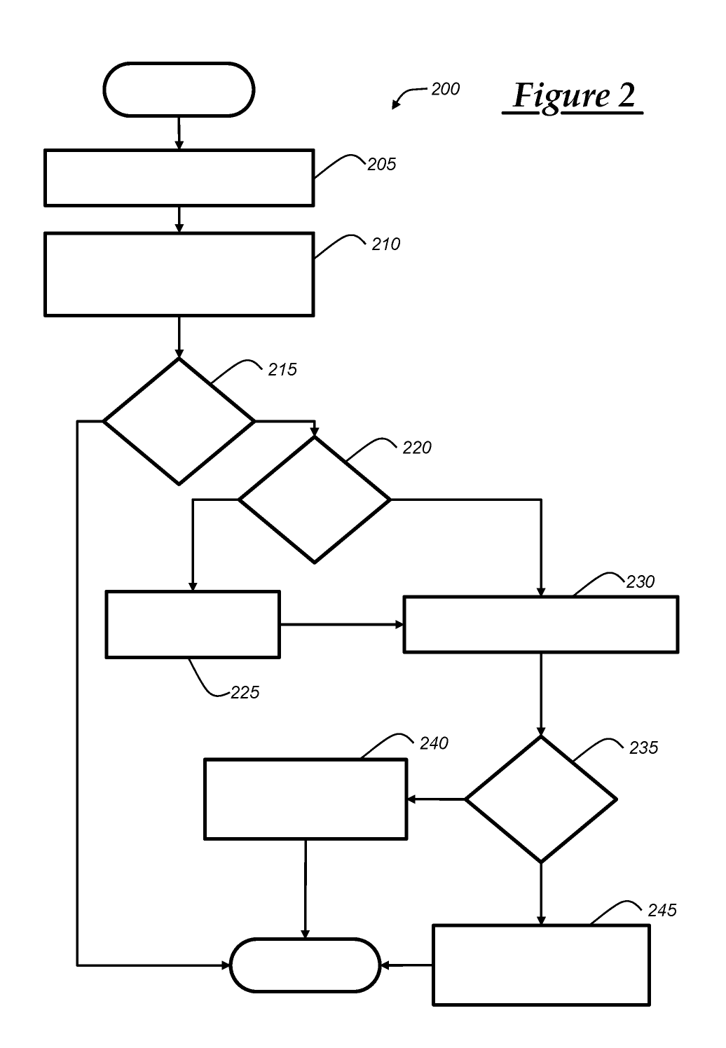

Turning now to FIG. 2, there is shown an embodiment of a method of facilitating installation of an application on a mobile device. Method 200 is carried out by vehicle 12 using its vehicle electronics 20. In the first step 205, the vehicle establishes short range communication with a mobile device. Vehicle 12 may establish a connection with mobile device 90 via a USB cord that is coupled to vehicle 12 and mobile device 90. Or, vehicle 12 may use any of the above-mentioned SRWC technologies and protocols to establish communication with mobile device 90. For example, Bluetooth™ may be used to establish a line of communication between the vehicle and the mobile device. The communication may be established in response to the user operating the mobile device or the vehicle. Alternatively, this step may be initiated and carried out in a completely autonomous fashion by the vehicle and/or the mobile device (e.g., as a result of a previous pairing of the two) such that the vehicle automatically establishes short range communication with the mobile device. Upon the establishment of communication between the vehicle and the mobile device, the method continues to step 210.

In step 210, the vehicle sends identification information to remote facility 80. The identification information may be, for example, data and/or information pertaining to the vehicle, the user, and/or the mobile device 90. It should be appreciated that the identification information need not be uniquely identifying information but in at least some embodiments may be merely information that identifies some property, state, aspect, or condition of the vehicle, the user, and/or the mobile device. Vehicle 12, in one embodiment, obtains the identification information from a memory device included in vehicle electronics 20, such as memory 54 in telematics unit 30. Additionally, or alternatively, vehicle 12 may receive information from mobile device 90 pertaining to the mobile device and/or the user, such as a MAC address of the device or an email address of the user. After the vehicle obtains the identification information, the vehicle may communicate this information to remote facility 80.

As described below, this identification information may be used by the remote facility 80 to determine eligibility of the user to access the vehicle via the mobile device 90 using the application 92. This eligibility may be based on various things, such as the type of vehicle, the type of mobile device, or the existence and/or type of a telematics services plan available to the user. For example, the purchase or lease of the vehicle by the user may include a subscription-based telematics service plan that is free to try for an initial period of time, and that permits the user to access the vehicle remotely via their mobile device 90 using the application 92. This remote access may include the ability to obtain vehicle information, such as operating status, tire pressure, location, as well as to control various vehicle features or operations, such as remote start, locking and unlocking of the vehicle, etc. Or, the eligibility may be determined at least partially based on whether the user has paid for such a subscription. Thus, the identification information sent will depend on how eligibility is determined for a particular implementation of the method 200.

In one embodiment of step 210, the vehicle may communicate the identification information to remote facility 80 using telematics unit 30 via cellular tower 70, MSC 72, and land network 16. In another embodiment, the vehicle may communicate the identification information to remote facility 80 via a cellular mobile device 90, cellular tower 70, MSC 72, and land network 16. In any event, the remote facility receives the identifying information and, at least in some embodiments, other information or data, such as metadata.

Next, in step 215, the vehicle receives a response from the remote facility 80 indicating eligibility of the user to control one or more vehicle operations via the mobile device 90 using the application 92. As noted above, the eligibility may be based at least partly on the vehicle, the user, the mobile device, and/or other information contained in the information that was sent to the remote facility in step 210. And it may be based at least partially on information available at the remote facility 80, such as the eligibility of the user and/or vehicle for a subscription-based service plan, or other such user subscription package enrollment information. The vehicle may receive this response via any of the above described communication paths between facility 80 and vehicle 12, such as, for example, those described with respect to step 210. Upon receiving the response, vehicle 12 may process the response using processing device 52 and/or store at least part of the response in memory 54. As part of the processing, the vehicle determines whether the user is eligible to control one or more vehicle operations using the application.

As used herein, “vehicle operations” refers to any operation that may be carried out by the vehicle and/or any operation pertaining to the vehicle including merely gathering information relating to the vehicle even if the vehicle performs no operation in achieving this feat. For example, a vehicle operation may be unlocking and locking the vehicle; in another example, a vehicle operation may be obtaining the vehicle's VIN number that is stored at a remote facility.

In one embodiment of step 215, the eligibility may be determined by vehicle 12 through analyzing the response. This may include merely analyzing a single bit that indicates whether the user is eligible. In another embodiment, this may include processing a list included in the response of all of the vehicle operations and/or types of operation that the user is eligible to control. After vehicle 12 determines the eligibility, the method proceeds to step 220 if the user is eligible to control at least one vehicle operation; otherwise, the method ends.

After eligibility is confirmed, the vehicle determines whether the application is installed on the mobile device, as shown in step 220. This step need not be carried out after steps 210 and 215; in other embodiments it may be done before or during these steps. In the illustrated embodiment, vehicle 12 will send a request to mobile device 90 to query whether it contains the mobile application. Vehicle 12 may indicate its request along with a unique identifier for the application, such as a unique application ID that was assigned to the application when the application was first uploaded to an app store (e.g., Google Play™, iTunes™). This may be carried out via Bluetooth™ or other SRWC. Mobile device 90 may then determine if the application 92 is installed or otherwise located thereon and then report this information back to vehicle 12. If the vehicle determines that the application is already installed on the device, then the method proceeds to step 230; otherwise, the method continues to step 225.

If the vehicle determined in step 220 that the application was not already installed on the mobile device, then the vehicle will prompt the user to install the application onto the mobile device, as illustrated in step 225. In one embodiment, vehicle 12 may prompt the user via a query asking whether the user wants to download and install application 92 onto mobile device 90. This may, for example, be carried out via visual display 38 and/or audio system 36. Upon user indicating that he or she wishes to download and install the application, the vehicle may retrieve a URL or other download link from remote facility 80 or from memory resident on board the vehicle (e.g., memory 54). The URL provides, for example, an HTTP link to a location wherefrom application 92 may be downloaded. Or, a different type of download link may be used; for example, an applications store (app store) link used by an app store program on the mobile device 90 to lookup the application on a remote server. Whether as a URL or otherwise, the download link may be provided to the mobile device to lookup and/or initiate download of the application 92, and techniques for providing this download link from the vehicle to the mobile device via, for example, Bluetooth™, will be apparent to those skilled in the art. Alternatively, vehicle 12 may download application 92 itself using the download link. Or, instead, vehicle 12 may request a download of the application from remote facility 80 to be done directly to the mobile device without going through the vehicle electronics. In any of the cases where the vehicle downloads the application, vehicle 12 will then transfer the application to device 90. Upon a successful download of application 92 from either a remote location over the Internet or from the vehicle, the mobile device will then, if necessary, run an installer or setup program to configure the device such that it may use the application. The method continues to step 230.

In step 230, the vehicle directs the mobile device to launch the application. In one embodiment, after vehicle 12 determines that application 92 is installed on device 90, the vehicle may store this data in memory 54 and then send the mobile device a command to launch the application. In another embodiment, vehicle 12 will send this command to launch the application as part of the same message it sent in step 220 when it requests the device to indicate whether the application is installed thereon. In any event, the application will be launched by the mobile device and the method will proceed to step 235.

In step 235, after the application is launched in step 230, the vehicle determines whether an account for the customer or vehicle is already set up. This may be carried out by vehicle 12 sending vehicle and/or customer data to the remote facility. In another embodiment, this step may take place before, after, or during step 225 and/or step 230. For example, this may be done as a part of step 210 such that the remote facility determines both eligibility and whether a user account has yet been established. The vehicle may send data via any of the means described above with respect to step 210 or as described above with respect to communication system 10. The data may pertain to mobile device 90, vehicle 12, and/or the user of the vehicle. In response to receiving this data, remote facility 80, or some other facility such as a server computer 18, may respond with an indication as to whether the vehicle and/or customer (e.g., the user) already has an account set up. The account may be a general account that the customer holds with the OEM or other telematics service provider, or may be an account that the user has set up specifically for use with application 92. The remote facility may receive, as part of the data sent by the vehicle, the VIN of the vehicle or an email address of the user. In any event, the response will indicate whether an account is already set up and may also provide other information. If there is an account already set up the method proceeds to step 245; otherwise, the method proceeds to step 240.

In step 240, the vehicle instructs the mobile device to initiate a create account page. This will facilitate easy setup of a new account through displaying a create account page. The create account page may be part of application 92 or may be a webpage that is navigated to via a browser on mobile device 90. In any event, the vehicle may provide additional information to the mobile device pertaining to the vehicle and/or the user, such as the user's email or the vehicle's VIN. The mobile device can then populate the appropriate input fields on the create account page using this additional information. The user may then complete the account setup process and start using the application 92 on their mobile device, and so the method then ends.

In step 245, after the vehicle determines an account was already set up, the vehicle instructs the mobile device to auto-populate the username in the application. The user may then login by providing a password or authenticating biometric input. In one embodiment, application 92 includes a login page which takes, as input, user credentials such as a username and a password. Here, vehicle 12 sends the mobile device a command to go to the application's login page, and may send the user's username that it retrieved, for example, from the account information at remote facility 80 in step 235. The mobile application then inserts the username into the corresponding “username” input field on the login page of the application. In another embodiment, step 230, wherein application 92 is launched, is incorporated as a first part of this step. In this case, step 220 (in the case of evaluating to a “Yes”) and step 225 would proceed directly to step 235.

Alternatively, the vehicle may instruct the application 92 to auto-login using authenticating information such as the username and password that is stored at the vehicle and/or in the application 92 on the device. Further, once the account has been fully set up, the vehicle can record this completion state of the application installation. That completion state may be used in subsequent iterations of the method 200 so that, for example, an additional step 207 (not shown) may be carried out after step 205 and before step 210 to have the method skip steps 210-245 where the application has already been fully installed and configured. The method then ends.

It is to be understood that the foregoing is a description of one or more embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation. In addition, the term “and/or” is to be construed as an inclusive OR. Therefore, for example, the phrase “A, B, and/or C” is to be interpreted as covering any one or more of the following: “A”; “B”; “C”; “A and B”; “A and C”; “B and C”; and “A, B, and C.”

1. A method of facilitating installation of an application on a mobile device wherein the method is carried out by a vehicle and wherein the method comprises the steps of:
(a) establishing short range communication with a mobile device of a user of the vehicle;
(b) sending identification information to a remote facility, wherein the identification information includes information pertaining to the vehicle, the user, and/or the mobile device;
(c) receiving a response from the remote facility indicating eligibility of the user to control one or more vehicle operations via the mobile device using the application;
(d) determining whether the application is installed on the mobile device; and
(e) prompting the user of the vehicle to install the application to the mobile device when it is determined that the application is not installed on the mobile device.

2. The method of claim 1, wherein the identification information sent to the remote facility includes a vehicle identification number that is associated with the vehicle.

3. The method of claim 1, wherein the eligibility of the user to control one or more vehicle operations is based at least partly on at least one or more of the following types of information: the identification information sent to the remote facility in step (b); vehicle and/or user subscription package enrollment information available at the remote facility; and mobile device information sent from the vehicle to the remote facility.

4. The method of claim 1, wherein step (d) further comprises the step of querying the mobile device to determine whether the application is installed thereon.

5. The method of claim 1, wherein step (e) further comprises requesting that the user indicate whether the application should be downloaded and/or installed to the mobile device.

6. The method of claim 5, further comprising the step of receiving an indication from the user that the application should be downloaded and/or installed to the mobile device and, in response thereto, directing the mobile device to download the application.

7. The method of claim 6, further comprising the step of providing the mobile device with a download link in response to the indication that the application should be downloaded, wherein the download link is a URL to a remote server or an app store link used by an app store program on the mobile device to lookup the application on a remote server.

8. The method of claim 6, further comprising the step of downloading the application to the vehicle and then sending the downloaded application to the mobile device in response to the indication that the application should be downloaded.

9. The method of claim 1, further comprising the step of directing the mobile device to launch the application when it is determined that the application is installed on the mobile device.

10. The method of claim 1, wherein step (d) is carried out before step (b).

11. The method of claim 1, further comprising the step of determining if there exists an account that is associated with the vehicle or with the user of the vehicle.

12. The method of claim 11, wherein the determination of the existence of the account further comprises carrying out as a part of steps (b) and (c) or thereafter, the steps of sending information pertaining to the vehicle or user of the vehicle to the remote facility and, subsequently, receiving a response thereto indicating whether there exists an account that is associated with the vehicle or with the user of the vehicle.

13. The method of claim 12, further comprising the step of directing the mobile device to launch a create account screen when it is determined that an account that is associated with the vehicle or with the user of the vehicle does not exist.

14. The method of claim 13, further comprising the step of directing the mobile device to launch the application such that the application displays an authentication input screen when it is determined that an account that is associated with the vehicle or with the user of the vehicle does exist.

15. The method of claim 14, wherein the authentication input screen contains at least one input fields and wherein one of the at least one input fields is populated by information sent by the vehicle to the mobile device.

16. A method of facilitating downloading of an application to a mobile device located at a vehicle wherein the method is carried out by the vehicle and wherein the method comprises the steps of:
(a) establishing communication with a mobile device of a user of the vehicle;
(b) in response to step (a), sending identification information to a remote facility that indicates that the user has a mobile device;
(c) receiving a response from the remote facility indicating eligibility of the user to access the vehicle via the mobile device using the application;
(d) prompting the user to indicate whether to download and/or install the application;
(e) receiving an indication from the user in response to step (c) that the application should be downloaded;
(f) accessing a download link for the application in response to the user's indication that the application should be downloaded; and
(g) using the download link to initiate download of the application to the mobile device.
